(19) United States
(12) Patent Application Publication
(10) Pub. No.: US 2025/0270144 A1
(43) Pub. Date: Aug. 28, 2025

(54) METHOD OF MANUFACTURING A POLYMER-COMPOSITE DIELECTRIC MATERIAL

(71) Applicant: UT-Battelle, LLC, Oak Ridge, TN (US)

(72) Inventors: Meghan Lamm, Oak Ridge, TN (US); Beth L. Armstrong, Oak Ridge, TN (US); Tolga Aytug, Knoxville, TN (US); Md S. Chowdhury, Knoxville, TN (US); Benjamin Lamm, Oak Ridge, TN (US); Kai Li, Farragut, TN (US)

(21) Appl. No.: 19/062,246

(22) Filed: Feb. 25, 2025

Related U.S. Application Data
(60) Provisional application No. 63/557,649, filed on Feb. 26, 2024.

(51) Int. Cl. C04B 35/634; C04B 35/465; C08J 3/09; C08J 3/205; C08J 5/18

(52) U.S. Cl. CPC C04B 35/63444; C04B 35/465; C08J 3/096; C08J 3/2053; C08J 5/18; C08J 2379/08

(57) ABSTRACT

A method of manufacturing a high-performance polymer-ceramic composite includes: mixing a high-temperature polymer with a solvent to obtain a first mixture; adding a high-energy-density ceramic material to the first mixture to obtain a second mixture; mixing a dispersant with the second mixture to obtain a slurry composition; tape-casting the slurry composition on a substrate at an elevated temperature of greater than or equal to 25° C.; drying the casted slurry composition to obtain a polymer-ceramic dielectric film; and annealing the polymer-ceramic dielectric film. The high-temperature polymer may be polyimide, the high-energy-density ceramic material may be calcium copper titanate. The solvent may be N-methyl-2-pyrrolidone. The dispersant may be an alkylol ammonium salt of an acidic copolymer having pendant amine and acid groups. A high-performance polymer-ceramic composite dielectric material and a high-temperature capacitor including the high-performance polymer-ceramic composite dielectric material manufactured by the method are also provided.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### CROSS-REFERENCE TO RELATED APPLICATIONS

This application claims the benefit of U.S. Provisional Application No. 63/557,649, filed Feb. 26, 2024, the disclosure of which is incorporated by reference in its entirety.

### FIELD OF THE INVENTION

The present invention relates to a method of manufacturing a polymer-composite dielectric material for electric vehicle batteries and other applications.

### BACKGROUND OF THE INVENTION

The transition to electrified transportation demands advanced power electronic components that can improve the range, reliability, and cost in order to accelerate mass market adoption of electric vehicles (EVs). The movement towards sustainability has therefore motivated development of advanced materials for on-and off-board electric vehicle applications, including power conversion systems (e.g., power electronic components), converters, batteries, wiring, interconnects, busbars, and charging systems. Among these, power conversion systems are essential for electrified transportation since increased electrification requires compact, efficient, and reliable operation of power electronic components. For instance, a conventional traction inverter includes a power module, DC bus capacitors, a controller, a gate driver, a heat sink, and ancillary units such as the casing, busbar, and connectors. The DC bus capacitor, power module, and heatsink take up 65% of the volume of an inverter, and the most volume (20-30%) is occupied by the DC bus capacitor due to the integration of multiple capacitors in parallel to handle higher currents. Additionally, the elevated operating temperature of the power systems in EV electronics (85° C. and higher) creates, among other things, thermal stresses that well exceed the normal operating level capabilities of presently available devices and components. To reduce size and volume as well as to enable high-temperature and high-frequency operation for power electronic systems, capacitor materials with high dielectric constants and high electric breakdown strengths that can function effectively at high temperatures (>200° C.) are desirable. High-temperature operation allows for higher current conduction capability, and a high dielectric constant and high breakdown voltage allows for improved energy density.

Current dielectric technology utilizes either polymeric or ceramic materials. While polymeric dielectrics possess high breakdown strengths and undergo a desirable graceful failure mechanism (i.e., self-healing), their low dielectric constant combined with material thermal degradation at high temperatures compromise their performance. On the other hand, high dielectric permittivity ceramic capacitors have desirable high energy density and do not degrade at high temperatures, but have low breakdown strengths and tend to crack due to thermal and mechanical shocks. This leads to an ungraceful short circuit failure and makes them unattractive especially for automotive applications. The current operating temperature of conventional film-based polymer capacitors is ˜105° C. (˜125° C. with derating), and those of ceramics can go up to 150° C. Hence, both polymer and ceramic capacitors cannot be tightly integrated with wide-bandgap based semiconductor switches, which generally can operate up-to 200° C. Thus, improvement and the identification of new materials and components capable of providing reliable and efficient operation at high temperature play important roles for future needs of power electronic systems.

### SUMMARY OF THE INVENTION

A method of manufacturing a high-performance polymer-ceramic composite is provided. The method includes mixing a high-temperature polymer with a solvent to obtain a first mixture. The method further includes adding a high-energy-density ceramic material to the first mixture to obtain a second mixture. The method further includes mixing a dispersant with the second mixture to obtain a slurry composition. The method further includes tape-casting the slurry composition on a substrate at an elevated temperature of greater than or equal to 25° C. The method further includes drying the casted slurry composition to obtain a polymer-ceramic dielectric film. The method further includes annealing the polymer-ceramic dielectric film.

In specific embodiments, the high-temperature polymer has a glass transition temperature greater than or equal to 200° C.

In specific embodiments, the high-temperature polymer is one or more selected from a group consisting of: polyimide (PI), polyamide-imide (PAI), polyetheretherketone (PEEK), polyetherketoneketone (PEKK), polyetherketone (PEK), polyethersulfone (PES), polyetherimide (PEI), polyphenylene sulfide (PPS), polytetrafluoroethylene (PTFE), polybenzimidazole (PBI), polyphthalamide (PPA), liquid-crystal polymer (LCP), and bisbenzocyclobutene (BCB).

In particular embodiments, the high-temperature polymer is polyimide (PI).

In specific embodiments, the high-energy-density ceramic material has a dielectric constant that is greater than or equal to 200 at a temperature greater than or equal to 25° C. and a frequency greater than or equal to 100 Hz.

In particular embodiments, the high-energy-density ceramic material is one or more selected from a group consisting of: calcium copper titanate (CCTO), barium titanate, lead lanthanum zirconium titanate (PLZT), and silver niobate.

In certain embodiments, the high-energy-density ceramic material is calcium copper titanate (CCTO).

In specific embodiments, the solvent is a high-boiling polar aprotic organic solvent.

In particular embodiments, the solvent is one selected from a group consisting of dimethylformamide (DMF), N-methyl-2-pyrrolidone (NMP), and dimethylacetamide (DMAC).

In specific embodiments, the dispersant is one or more selected from a group consisting of: an alkylol ammonium salt, a polyglycol polyester modified polyalkylene imine, a modified styrene-maleic acid copolymer, a phosphoric acid ester, and a charged, amphiphilic or zwitterionic compound.

In particular embodiments, the dispersant is an alkylol ammonium salt of an acidic copolymer.

In certain embodiments, the dispersant is an alkylol ammonium salt of an acidic copolymer having pendant amine and acid groups.

In specific embodiments, a content of the high-temperature polymer in the first mixture is in a range of approximately 5 to 25 wt. %.

In particular embodiments, the content of the high-temperature polymer in the first mixture is in a range of approximately 10 to 25 wt. %.

In specific embodiments, a content of the high-energy-density ceramic material in the second mixture is in a range of approximately 20 to 50 vol. %.

In particular embodiments, the content of the high-energy-density ceramic material in the second mixture is in a range of approximately 30 to 45 vol. %.

In specific embodiments, a content of the dispersant in the slurry composition is in a range of approximately 1 to 5 wt. %.

In particular embodiments, the content of the dispersant in the slurry composition is in a range of approximately 3 to 5 wt. %.

In specific embodiments, the annealed polymer-ceramic dielectric film has a dielectric constant that is greater than 200 at 100 Hz and 25° C.

Also disclosed is a high-temperature capacitor including the high-performance polymer-ceramic composite dielectric material manufactured by the method according to the embodiments above.

Additionally, a high-performance polymer-ceramic composite dielectric material is disclosed. The material includes a high-temperature polymer having a glass transition temperature greater than or equal to 200° C., a high-energy-density ceramic material having a dielectric constant that is greater than or equal to 200 at a temperature greater than or equal to 25° C. and a frequency greater than or equal to 100 Hz, and a dispersant. The high-performance polymer-ceramic composite dielectric material has a dielectric constant that is greater than 200 at 100 Hz and 25° C. The high-performance polymer-ceramic material may be formed according to a method as described above. The high-temperature polymer, high-energy-density ceramic material, and dispersant may be present in amounts as described above.

These and other features of the invention will be more fully understood and appreciated by reference to the description of the embodiments and the drawings.

### BRIEF DESCRIPTION OF THE DRAWINGS

FIG. 1 is a flow diagram of a method of manufacturing a high-performance polymer-ceramic composite dielectric material in accordance with embodiments of the disclosure;

FIG. 2 is a graph of dielectric constant values as a function of calcium copper titanate (CCTO) vol. % of CCTO/PI composites prepared using a 10 wt. % polyimide (PI) in NMP solution;

FIG. 3 is a graph of dielectric constant values of the composites as a function of CCTO vol. % and frequency;

FIG. 4 is a graph of dielectric constant values of the composites as a function of temperature and frequency;

FIG. 5 is a pictorial view of a scanning electron microscope (SEM) of a 40 vol. % CCTO/PI composite without dispersant;

FIG. 6 is a graph of the zeta potential for CCTO with and without various dispersants;

FIG. 7 is a graph of the particle size distribution for CCTO with and without the various dispersants;

FIG. 8 is a graph of dielectric constant values as a function of frequency for CCTO/PI composites at 45 vol. % CCTO and 20 wt. % PI with various dispersant wt. % in accordance with embodiments of the disclosure;

FIG. 9 is a graph of a comparison of actual and final CCTO volume percentages for CCTO/PI composites with and without dispersant;

FIG. 10 is a graph of dielectric constant values as a function of frequency for CCTO/PI composites at 45 vol. % CCTO, 5 wt. % dispersant, and various wt. % PI;

FIG. 11A is a pictorial view of a low-resolution SEM image of a CCTO/PI composite at 45 vol. % CCTO, 5 wt. % dispersant, and 20 wt. % PI in accordance with embodiments of the disclosure;

FIG. 11B is a pictorial view of a high-resolution SEM image of the CCTO/PI composite at 45 vol. % CCTO, 5 wt. % dispersant, and 20 wt. % PI;

FIG. 12 is graph of dielectric constant values as a function of frequency for CCTO/PI composites at 20 wt. % PI, 5 wt. % dispersant, and various vol. % CCTO;

FIG. 13 is a graph of dielectric constant values as a function of frequency for CCTO/PI composites at 30 vol. % CCTO, 5 wt. % dispersant, and various wt. % PI;

FIG. 14 is a pictorial view of an SEM image of a CCTO/PI composite at 30 vol. % CCTO, 5 wt. % dispersant, and 25 wt. % PI in accordance with embodiments of the disclosure;

FIG. 15 is a graph of dielectric constant values for a CCTO/PI composite in accordance with embodiments of the disclosure and for conventional CCTO/PI composites at 100 Hz and 25° C.;

FIG. 16 is a pictorial view of an SEM image of a CCTO/PI composite at 30 vol. % CCTO, 5 wt. % dispersant, and 15 wt. % PI in accordance with embodiments of the disclosure;

FIG. 17 is a pictorial view of an SEM image of a CCTO/PI composite at 30 vol. % CCTO, 5 wt. % dispersant, and 20 wt. % PI in accordance with embodiments of the disclosure;

FIG. 18 is a graph of dielectric constant values as a function of frequency for CCTO/PI composites at 30 vol. % CCTO and various wt. % PI with and without dispersant;

FIG. 19 is a graph of a Wiebull plot indicating breakdown strength for a CCTO/PI composite at 30 vol. % CCTO, 15 wt. % PI, and 5 wt. % dispersant in accordance with embodiments of the disclosure;

FIG. 20 is a graph of heat flow as a function of temperature for the CCTO/PI composite at 30 vol. % CCTO, 15 wt. % PI, and 5 wt. % dispersant, indicating a glass transition temperature of approximately 265° C.; and

FIG. 21 is a graph of dielectric constant values as a function of temperature and frequency for the CCTO/PI composite at 30 vol. % CCTO, 15 wt. % PI, and 5 wt. % dispersant.

### DETAILED DESCRIPTION OF THE CURRENT EMBODIMENTS

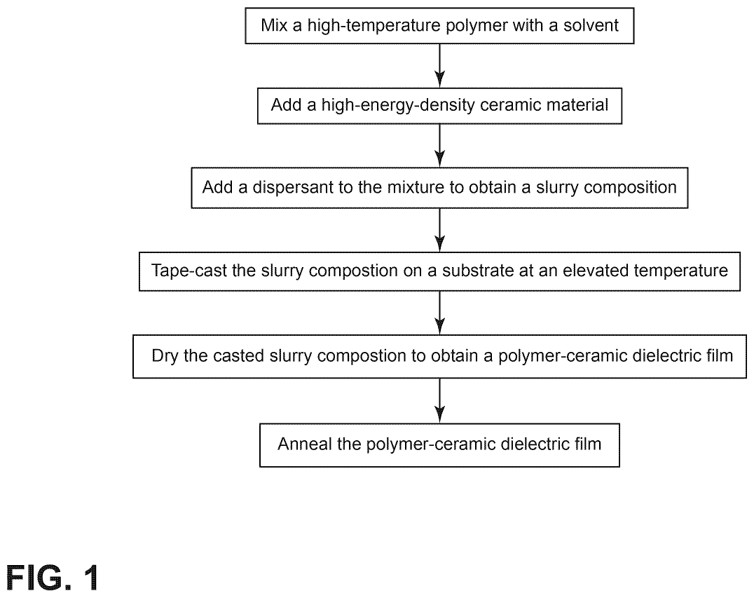

As discussed herein, the current embodiments relate to a method of manufacturing a high-performance polymer-ceramic composite dielectric material, and high-performance polymer-ceramic composite dielectric materials for use in such applications as high-temperature capacitors. As generally illustrated in FIG. 1, the method includes mixing a high-temperature polymer with a solvent, adding a high-energy-density ceramic material, mixing a dispersant into the mixture, tape-casting the obtained slurry composition, drying the casted slurry composition to obtain a polymer-ceramic dielectric film, and annealing the polymer-ceramic dielectric film. The obtained polymer-ceramic composite dielectric material includes a high-energy-density ceramic material in a high-breakdown-strength and high-temperature polymer with colloidal stabilization via a dispersant agent. The polymer-ceramic composite dielectric material can be utilized to form a high-temperature capacitor or capacitor bank with much higher energy density and breakdown voltage, ensuring power-dense traction inverters for EV applications. Each step is separately discussed below.

The method first includes mixing a high-temperature polymer with a solvent to obtain a first mixture. The high-temperature polymer is a polymer having a glass transition temperature (T_{g}) that is 200° C. or higher. The high-temperature polymer is resistant to heat and can withstand a temperature of at least 200° C. without significant change or loss in mechanical properties. The withstand temperature of the high-temperature polymer is therefore necessarily less than the melting temperature (Tₘ) of the polymer. In various embodiments, the high-temperature polymer may be polyimide (PI), polyamide-imide (PAI), polyetheretherketone (PEEK), polyetherketoneketone (PEKK), polyetherketone (PEK), polyethersulfone (PES), polyetherimide (PEI), polyphenylene sulfide (PPS), polytetrafluoroethylene (PTFE), polybenzimidazole (PBI), polyphthalamide (PPA), liquid-crystal polymer (LCP), bisbenzocyclobutene (BCB), or a combination of two or more of these polymers. In exemplary embodiments, the high-temperature polymer is a polyimide.

The solvent is generally a high-boiling polar aprotic organic solvent. By high-boiling, it is meant that the solvent has a boiling temperature that is generally greater than approximately 100° C., more preferably greater than approximately 125° C., even more preferably greater than approximately 150° C. The high-boiling organic solvent also may be a polar aprotic solvent with the polarity of the solvent leading to its higher boiling point. In various embodiments, the solvent may be dimethylformamide (DMF), N-methyl-2-pyrrolidone (NMP), dimethylacetamide (DMAC), another high-boiling polar aprotic solvent, or a combination of two or more of these solvents. DMF has a boiling point of approximately 153° C., DMAC has a boiling point of approximately 165° C., and NMP has a boiling point of approximately 202 to 204° C. In exemplary embodiments, the solvent is N-methyl-2-pyrrolidone.

The content of the high-temperature polymer in the first mixture, and thus the amount of high-temperature polymer relative to the combined total amount of solvent and high-temperature polymer, is in a range of approximately 5 to 25 wt. %, optionally in a range of approximately 10 to 25 wt. %, optionally in a range of approximately 15 to 25 wt. %, optionally in a range of approximately 20 to 25 wt. %, optionally in a range of approximately 5 to 20 wt. %, optionally in a range of approximately 10 to 20 wt. %. In some embodiments, the content of the high-temperature polymer is around 15 wt. %.

The method then includes adding a high-energy-density ceramic material to the first mixture to obtain a second mixture. However, it should be understood that the high-energy-density ceramic material may be added to the solvent simultaneously with the high-temperature polymer. By high-energy-density, it is meant that the ceramic material has an appreciable energy density in comparison to other materials. For example, the high-energy-density ceramic material may have a dielectric constant that is greater than or equal to approximately 200 at a temperature greater than or equal to approximately 25° C. and a frequency greater than or equal to approximately 100 Hz. In various embodiments, the high-energy-density ceramic material has a dielectric constant that is in a range of approximately 200 to 5000 or higher. The high-energy-density ceramic material may be one or a combination of calcium copper titanate (CCTO), barium titanate, lead lanthanum zirconium titanate (PLZT), and silver niobate. In exemplary embodiments, the high-energy-density ceramic material is calcium copper titanate.

The content of the high-energy-density ceramic material in the second mixture is in a range of approximately 20 to 50 vol. % based on the total volume of the second mixture, which is the total volume of solvent, high-temperature polymer, and high-energy-density ceramic material. Optionally, the content of the high-energy-density ceramic material in the second mixture is in a range of approximately 20 to 45 vol. %, optionally in a range of approximately 30 to 45 vol. %, optionally in a range of approximately 35 to 45 vol. %, optionally in a range of approximately 40 to 45 vol. %, optionally in a range of approximately 25 to 40 vol. %, optionally in a range of approximately 30 to 40 vol. %. In some embodiments, the content of high-energy-density ceramic material is around 45 vol. %.

The method also includes mixing a dispersant with the second mixture to obtain a slurry composition. However, it should be understood that the dispersant may be added to the solvent simultaneously with the high-temperature polymer and/or the high-energy-density ceramic material, or alternatively may be added to the solvent before the high-temperature polymer and/or the high-energy-density ceramic material. In all embodiments, the resulting slurry composition includes the high-temperature polymer, the high-energy-density ceramic material, and the dispersant. In various embodiments, the dispersant is one or any combination of an alkylol ammonium salt, a polyglycol polyester modified polyalkylene imine, a modified styrene-maleic acid copolymer, a phosphoric acid ester, and other charged, amphiphilic or zwitterionic compounds. In exemplary embodiments, the dispersant is an alkylol ammonium salt of an acidic copolymer, particularly an alkylol ammonium salt of an acidic copolymer having pendant amine and acid groups.

The content of the dispersant in the slurry composition as a weight percent relative to the weight of the high-energy-density ceramic material is in a range of approximately 1 to 5 wt. %, optionally in a range of approximately 2 to 5 wt. %, optionally in a range of approximately 3 to 5 wt. %, optionally in a range of approximately 4 to 5 wt. %, optionally in a range of approximately 1 to 4 wt. %, optionally in a range of approximately 1 to 3 wt. % optionally in a range of approximately 1 to 2 wt. %. In some embodiments, the content of the dispersant is around 5 wt. %.

The method next includes tape-casting the slurry composition on a substrate at an elevated temperature of greater than or equal to approximately 25° C., the temperature being elevated relative to room temperature. The substrate may include a heated surface, such as, for example, a heated silicon-coated mylar sheet that is heated to a temperature of approximately 125° C. The mylar sheet may be heated by a hot plate or other similar heating device. The tape-casting step includes spreading the slurry composition on the substrate to form a thin layer of slurry material. The slurry composition may be spread using a doctor blade, drawdown bar, or a slot die. After spreading, the layer of slurry material may be calendared to further densify the layer.

The method then includes drying the casted slurry composition to obtain a polymer-ceramic dielectric film. The drying may be performed, for example, directly on the heated surface and/or under ambient conditions. Drying of the casted slurry composition removes the solvent by evaporation.

Subsequent to drying, the method next includes annealing the polymer-ceramic dielectric film to obtain the high-performance polymer-ceramic composite dielectric material. The annealing step may be performed in a vacuum furnace at a temperature in a range of approximately 25 to 350° C. for a time period of between approximately 1 and 5 hours. The annealing step is required to cure the polymer. The annealed polymer-ceramic dielectric film has a dielectric constant that is greater than approximately 200 at 100 Hz and 25° C.

In certain applications, the high-performance polymer-ceramic composite dielectric material may be used as to form a high-temperature capacitor of a battery cell.

### EXAMPLES

The present method is further described in connection with the following laboratory examples, which are intended to be non-limiting.

Calcium copper titanate (CCTO) having an average particle size of 300 nm (99% purity) was obtained from Stanford Advanced Materials and dried at 150° C. Polyimide (PI) was obtained from Ensinger Plastics (Teca Powder P84) and dissolved in NMP (≥99.8%) obtained from J.T. Baker at varying weight ratios using a slow roller mill prior to sample preparation. Dispersants were obtained from BYK USA including BYK 9077, BYK-ET 3001, BYK-ET 3002, BYK-ET 3003, and BYK-ET 3004.

PI/NMP solution and CCTO at certain weight and volume ratios were placed in a small jar with five pieces of milling balls. The jar was placed on a slow roller mill for 24 to 48 hours for mixing and de-airing of the polymer-ceramic slurry formulation. The polymer-ceramic slurry was first cast onto silicone-coated mylar sheets on a hot plate at 125° C. using a 400 μm thick doctor blade set, and then completely dried on the hot plate prior to post annealing in a vacuum furnace at a heating rate of 4° C. per minute first at 200° C. for 30 minutes followed by further heating at 350° C. for 1 to 4 hours (ramp rate of 2° C./minute), before cooling to room temperature at a rate of 5° C./minute. Annealing of the PI was required to cure the polymer structure.

The morphology of the composites was evaluated using a Zeiss Merlin VP high-resolution field-emission scanning electron microscope (SEM). To prevent charging of the surface for analysis and imaging, the specimens were coated with a thin layer of iridium prior to imaging.

The final mass percentage (solids loadings) of CCTO in the fully annealed films was determined by thermogravimetric analysis (TGA) using a TA Instruments Q500 apparatus. The samples were heated from room temperature to 600° C. at a ramp rate of 10° C./minute under air flow.

Differential Scanning calorimetry (DSC) was performed on a TA Instruments Q2000 apparatus using heat/cool/heat mode to determine the glass transition temperature of the polymer matrix. Each sample was equilibrated at 25° C. before being heated to 300° C., cooled to 25° C., and heated back to 300° C. at a rate of 10° C./minute for each step.

Zeta potential measurements were collected by phase angle light scattering using a Brookhaven ZetaPals. Zeta potential values were measured from an average of 10 runs of 10 measurements. Particles were dispersed in 2.5 ml of NMP and subsequently diluted into 10 ml of the solvent at a resulting concentration of 5×10^{-5/}ml. Solutions were made with and without the selected dispersants (BYK 9077, BYK-ET 3001, BYK-ET 3002, BYK-ET 3003, and BYK-ET 3004) at 1 wt. % solid weight dispersant concentration. The particle/agglomerate size of each was also tested with dynamic light scattering (DLS) on the same system using the solutions prepared for zeta potential measurements.

The prepared samples were cut into 1 cm by 1 cm pieces, and the average thickness was measured using a commercial micrometer. To evaluate the dielectric performance, copper electrodes were attached to the samples using conductive silver paste. The samples were then cured in an oven at 60° C. for 2 to 4 hours to have better adhesion between the electrodes and the composite film. A precision Keysight impedance analyzer (E4990A) was used to evaluate the impedance curve and the phase angle of the capacitor under test (CUT). The results were then post-processed to evaluate the dielectric constant of the CUT.

The breakdown voltage was evaluated right after the dielectric constant measurement on the same sample. The breakdown was measured by inserting sample films between two spherical dome electrodes (IEC 60156), immersing the electrodes and samples in Univolt 61 dielectric oil, and connecting to a Phenix LD60 High Voltage Source. The source was ramped at a rate of 500 V/s until a failure was detected. The film was inspected after breakdown to confirm localized failure and moved to another area to repeat the test after the oil was stirred to minimize the impact of contamination. Before and after the breakdown testing for a given sample, a baseline measurement of the oil was carried out to confirm that the baseline dielectric strength of the oil was at least a factor of three greater than the sample under similar conditions. This approach was selected over direct deposition of electrodes given the conductive nature of the nanoparticles.

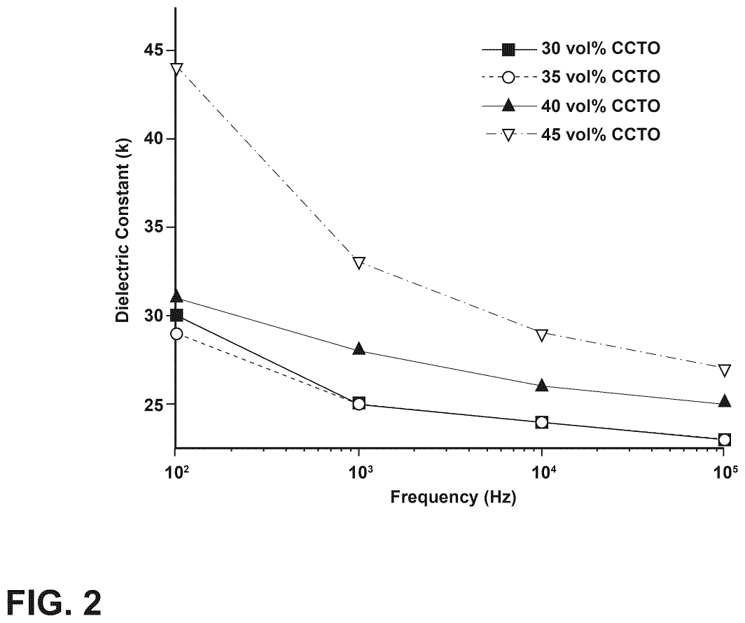

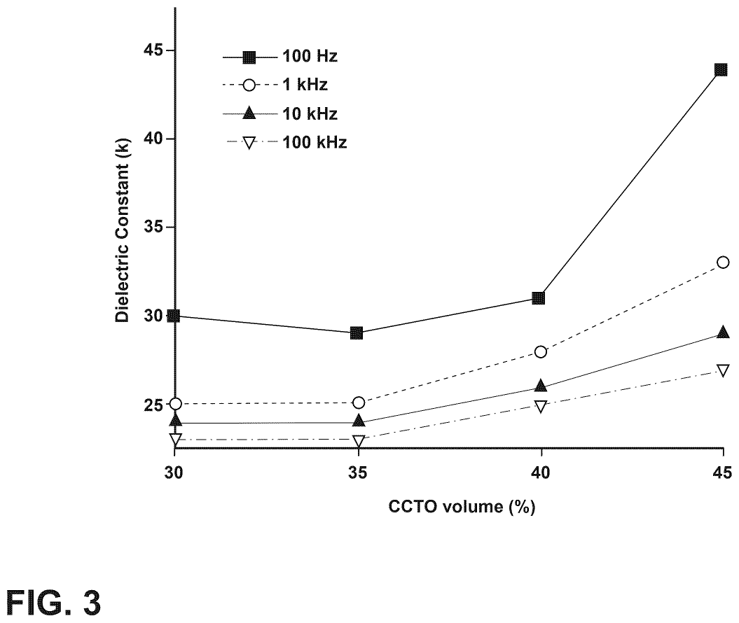

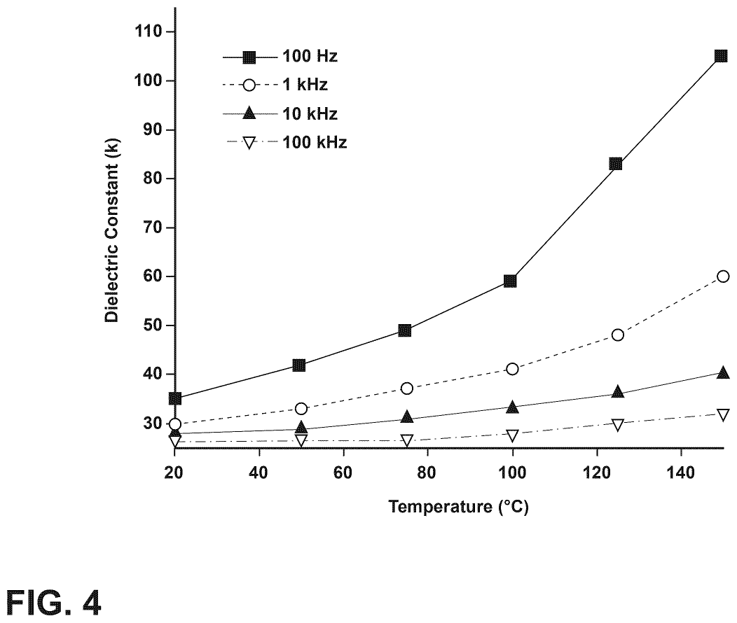

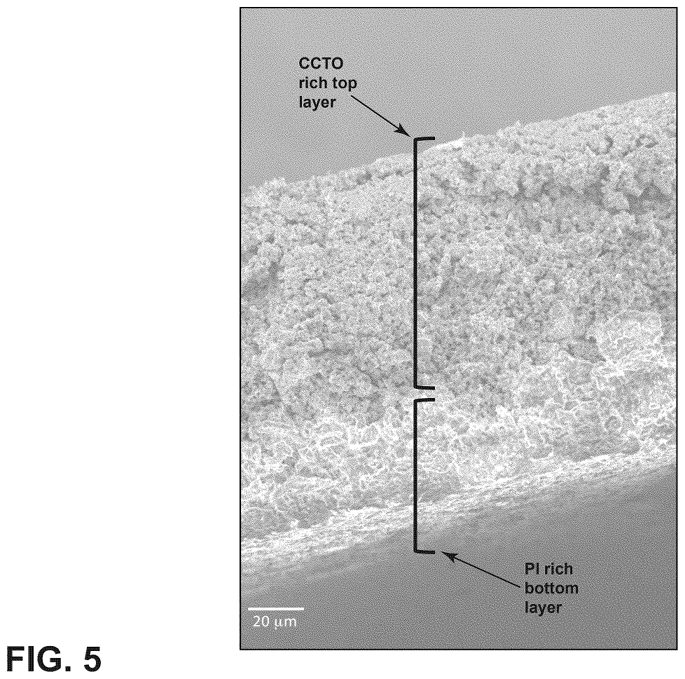

A parametric study was followed to maximize the dielectric constant of the PI/CCTO composites. First, the influence of CCTO loading on dielectric constant was investigated in a 10 wt. % solution of PI in NMP. FIGS. 2-4 clearly illustrate an increasing trend between the CCTO concentration and dielectric performance, with 45 vol. % CCTO achieving the highest dielectric constant of 43. Casting 50 vol. % CCTO was found to be difficult due to unstable solution conditions, leading to significant agglomeration and settlement of CCTO. While the obtained dielectric values were consistent with previously observed results, they were lower than expected, which may be related to poor dispersion of the CCTO in the PI/NMP solution resulting in the separation of the CCTO powder from the polymer solution. The SEM image of a CCTO/PI composite containing 40 vol. % CCTO is shown in FIG. 5 and clearly displays a layer of the polymer along the bottom (casting) surface of the casted sample (right-side in the image). This is consistent with poor interaction, and thus dispersion, between the ceramic and polymer matrix. The annealing procedure was adopted to remove water at 200° C. prior to annealing at 350° C. for 1-4 hours to cure the polyimide matrix. A 2-hour annealing time produced stable, free-standing samples, while longer annealing times of 3 or 4 hours resulted in browning of the sample edges, which was undesirable and likely due to decomposition of the polyimide matrix.

To overcome the dispersion issues between ceramic and polymer matrix, a variety of dispersant agents were tested. The dispersant acts as a steric, and potentially as a chemical stabilizing additive, to adsorb onto the CCTO particles in the PI suspension, providing more repulsive forces between the CCTO particles, thus leading to a stable dispersion. Alternatively, a lack of a dispersant produces a dispersion which due to attractive forces, causes agglomeration of the particles and ultimately separation of the CCTO from the PI resulting in settling or redistribution of both the CCTO and PI during casting and drying. As a steric additive is adsorbed onto a powder surface, the size or chain length of the additive increases the distance of the surface attractive forces. If too little additive is used, the attractive energy forces cannot be overcome. On the other hand, too much additive not only adds unnecessary material interfaces, which may impede dielectric properties, but may also contribute to more powder agglomeration due to entanglement. Hence, it is important to optimize the level of dispersant in order to control slurry stability and to also enable microstructural control in the film's final structure.

To evaluate the stability and size of particles in suspension, a combination of zeta potential and particle size distribution measurements were used. Five commercially available dispersants were utilized. Each of these dispersants featured a different chemical composition as summarized in Table 1 below.

TABLE 1
Dispersants

| Dispersant | Composition |
|---|---|
| BYK-9077 | polyglycol polyester modified polyalkylene imine |
| BYK-ET-3001 | alkylol ammonium salt of an acidic copolymer |
| BYK-ET-3002 | modified styrene-maleic acid copolymer |
| BYK-ET-3003 | phosphoric acid ester |
| BYK-ET-3004 | alkylol ammonium salt of a copolymer with acidic groups |
| | with a high amine and acid content |

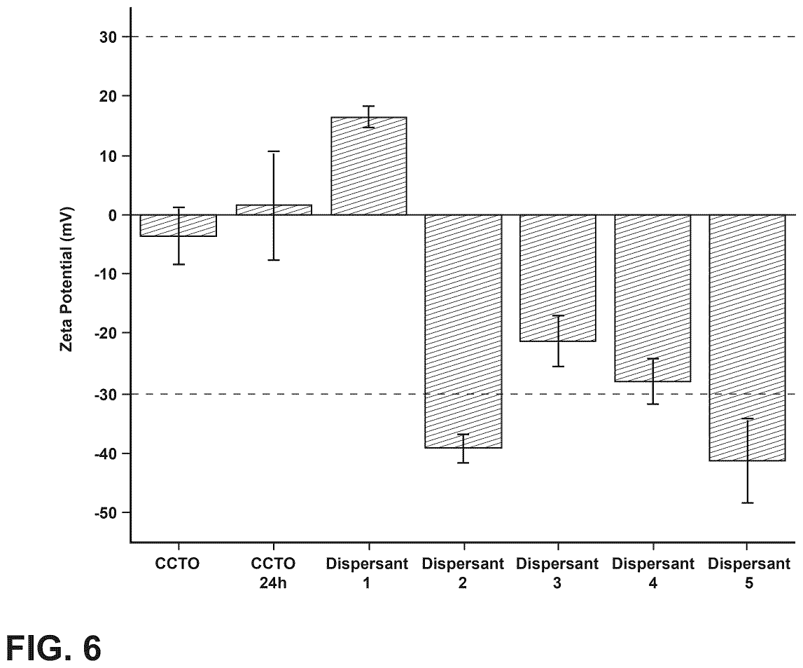

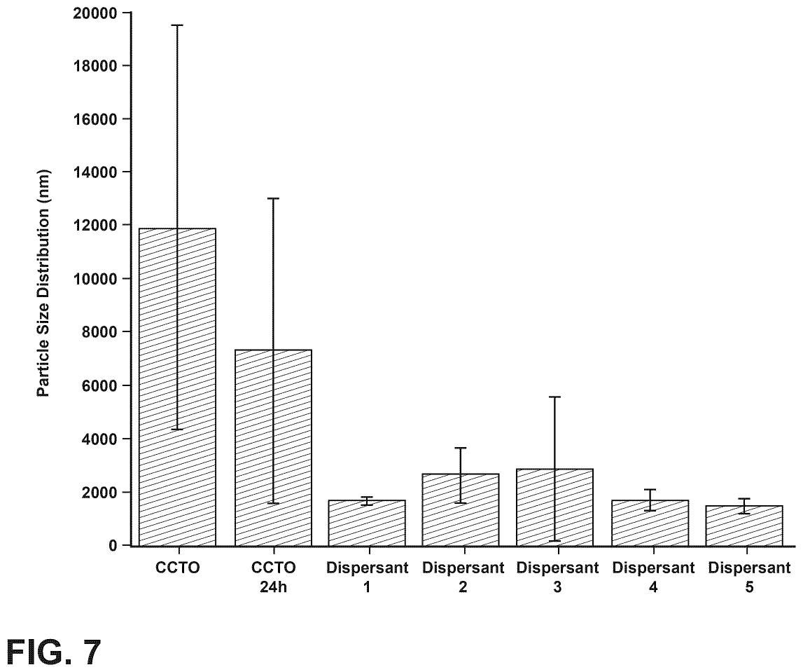

All these dispersants have charged groups in their structure, which helps to stabilize the ceramic particles sterically and chemically in solution. Based on the zeta potential results shown in FIG. 6, only two dispersants (BYK-ET-3001 and -3004) sufficiently stabilized the CCTO/PI solutions, as zeta potential showed values less than −30 mV. Interestingly, both of these dispersants feature similar chemistry, namely alkylol ammonium salt of an acidic copolymer featuring both pendant amine and acid groups, to produce chemical stabilization at varying degrees of functionalization. This means both dispersants produce a stable dispersion using both steric and chemical stabilization compared to some of their counterparts, which only use either steric or chemical stabilization. As shown in FIG. 7, all five dispersants produced a much smaller particle distribution compared to neat CCTO even after aging the neat CCTO for 24 hours in solution. Since BYK-ET-3004 resulted in a smaller average particle size compared to BYK-ET-3001, the remainder of the testing focused on samples prepared with BYK-ET-3004 as the dispersant.

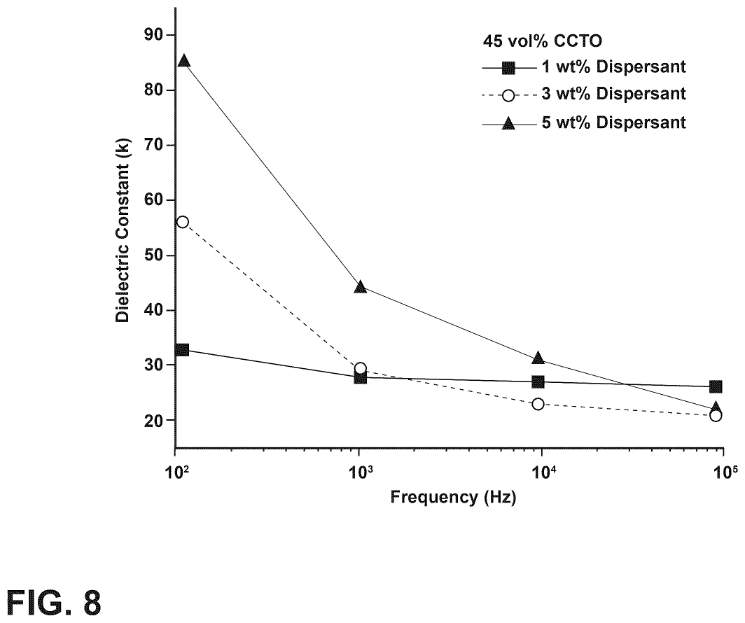

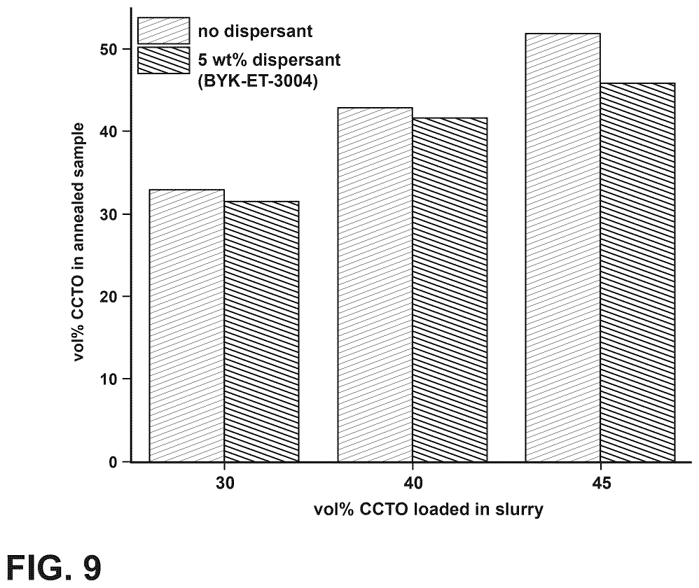

As discussed above, it is important to add enough dispersant to stabilize the ceramic particles without causing further agglomeration. Therefore, three samples containing 1, 3, and 5 wt. % of BYK-ET-3004 (relative to the weight of the CCTO in solution) were prepared and characterized. As shown in FIG. 8, a 5 wt. % concentration of dispersant produced the highest dielectric constant up to the measured maximum frequency of 10⁵ Hz, at which point all samples demonstrated similar performance. Note that at lower frequencies, while the dielectric constant of the 1 wt. % sample did not show appreciable change, samples with 3 wt. % and 5 wt. % dispersant showed improved dielectric constants, nearly doubling or tripling the dielectric constant of the neat CCTO polymer composite (˜27), respectively. Hence, 5 wt. % dispersant was subsequently used for all samples. Dispersant levels greater than 5 wt. % were not evaluated as 5 wt. % appeared to be the maximum dispersant concentration. Higher concentrations led to high viscosity of the slurry mixture thus impeding proper casting. Accordingly, TGA analysis was used to confirm that the presence of dispersant helps to produce a stable suspension. As shown in FIG. 9, the final concentration of CCTO in the composite was compared to the volume fraction used in the initial formulation. In composites without dispersion, there was a clear difference in CCTO loadings used in the formulation versus what is actually found in the fabricated composite. The difference became more apparent at higher CCTO loadings, where the difference was greater than 5 vol. %. On the other hand, for the composites containing dispersant, no appreciable difference was observed between the initial and final loadings, indicating that a stable suspension was maintained through the mixing and casting steps, in agreement with the zeta potential measurements.

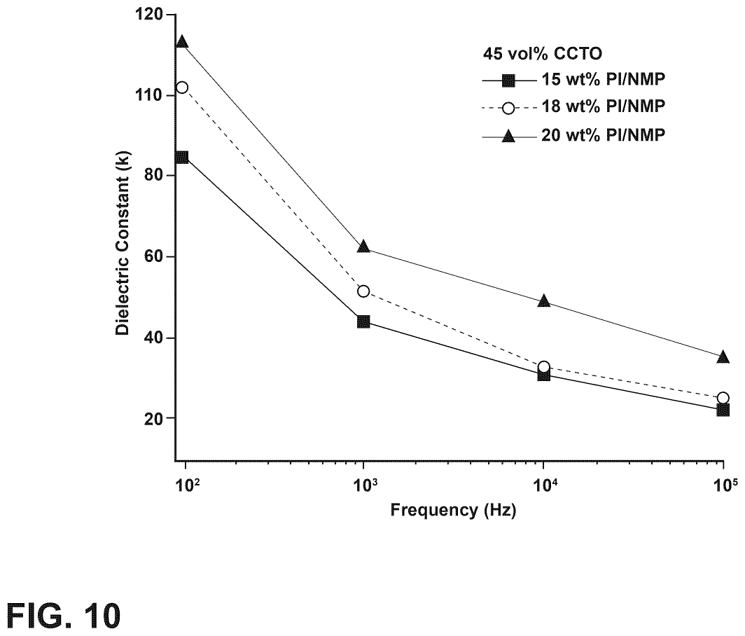

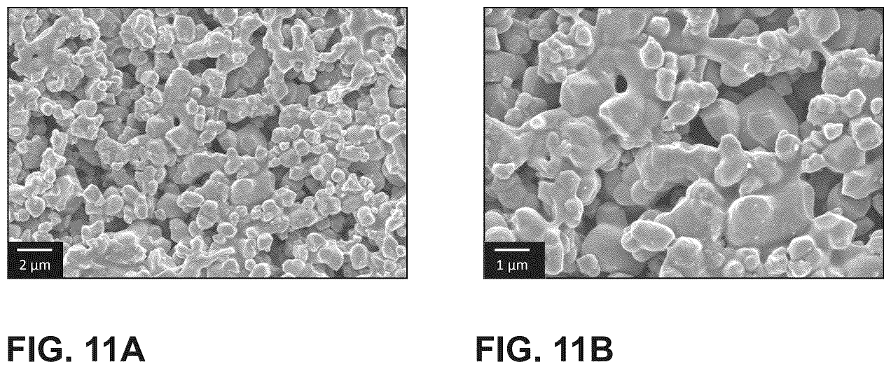

These tested composites, despite containing 5 wt. % of dispersant, still exhibited poor performance at high frequencies, perhaps due to the presence of some CCTO agglomeration in the samples. To assess this, samples containing 45 vol. % CCTO were prepared with different PI loadings (15, 18, and 20 wt. %). FIG. 10 shows that a concentration of 20% PI can produce the best high-frequency performance which approximately 20% higher than those obtained for lower PI concentrations. Low-and high-resolution SEM images of the CCTO/PI composites having 45 vol. % CCTO, 20 wt. % PI, and 5 wt. % dispersant are shown in FIGS. 11A-B, illustrating interconnected CCTO particles throughout the polymer matrix. Accordingly, it was found that the PI concentration needed for an optimal coverage of the CCTO particles was directly proportional to the CCTO content. Therefore, any change in the CCTO loading requires optimization of the PI content.

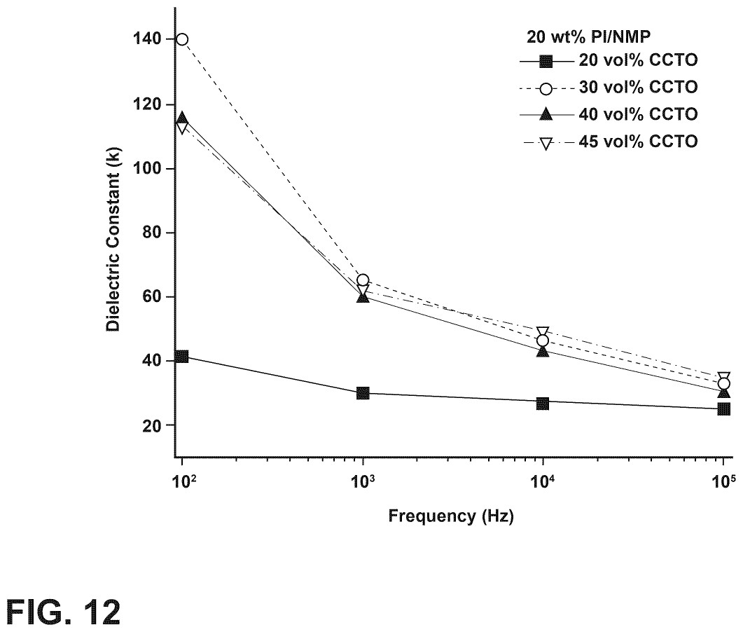

While the actual reasons behind the poor performance at high frequencies were not clearly identified, CCTO concentration was believed to play a major role. Higher CCTO content produced improved high frequency performance as observed previously and discussed above. Nevertheless, to test this hypothesis, samples containing 5 wt. % dispersant, 20 wt. % PI/NMP, and differing amounts of CCTO ranging from 20-45 vol. % were prepared. FIG. 12 shows that there was minimal change in performance between the samples at high frequencies, indicating that with good dispersion of the CCTO, there is no significant correlation between the CCTO content and dielectric constant. Surprisingly, at low frequencies the 30 vol. % CCTO-containing sample demonstrated the highest dielectric performance, being approximately 20% higher than its counterparts at 100 Hz. This suggested that a lower loading of CCTO could be used to produce the same performance at high frequencies at a lower cost, as the ceramic particles are more expensive than the polymer matrix.

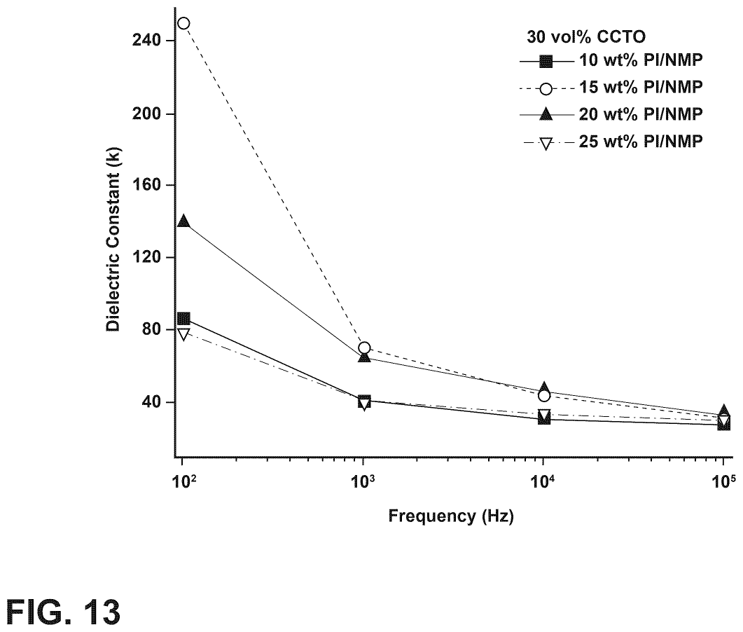

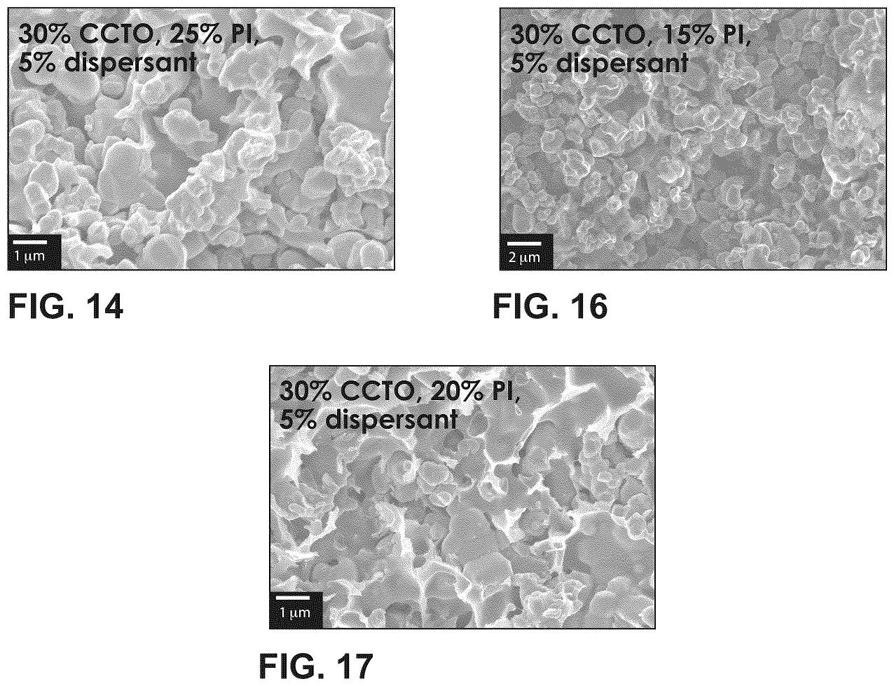

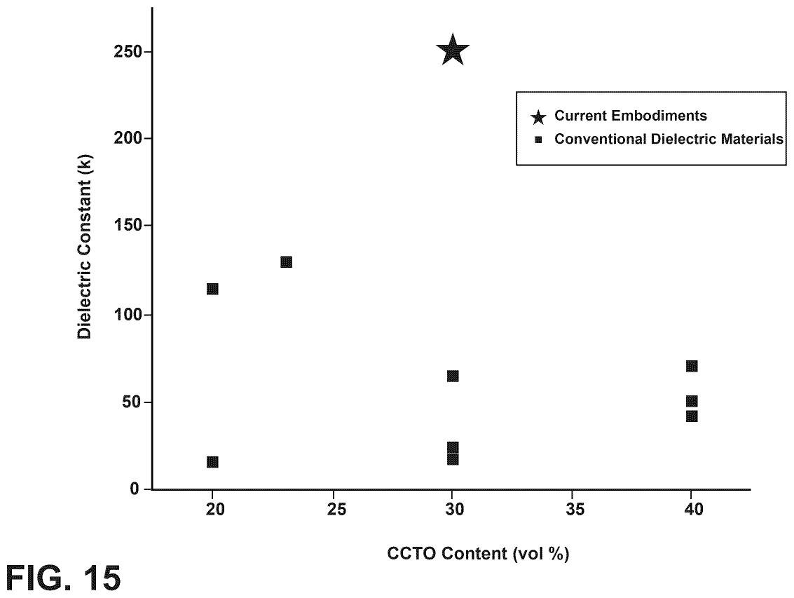

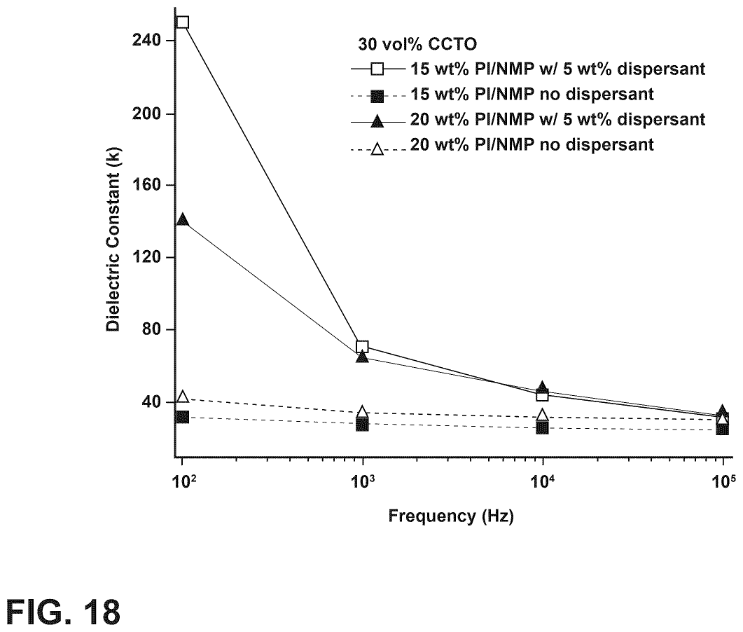

With 30 vol. % CCTO producing such good performance, and since dielectric performance is directly proportional to the CCTO and PI concentration as discussed above, next the weight percent of PI used in the dispersion formulation was optimized by keeping the loading of CCTO constant at 30 vol. %. A formulation of 30 vol. % CCTO with 5 wt. % dispersant was used to produce samples with PI in the range of 10-25 wt. %. The data shown in FIG. 13 revealed low dielectric performance for samples having low and high amounts of PI (15 wt. % and 25 wt. %), likely due to agglomeration of the ceramic particles and separation from the polymer matrix as shown in FIG. 14. On the other hand, the 15 wt. % PI sample demonstrated a remarkable performance with a dielectric constant of 250 at 100 Hz and 25° C., which has not been observed in previous studies of non-functionalized PI/CCTO composites as shown in FIG. 15. The morphology of this sample illustrated well-dispersed particles that are coated in a minimal amount of polymer matrix as shown in FIG. 16. Accordingly, while the performance of the 20 wt. % PI-containing sample was better than the 10 wt. % and 25 wt. % samples, albeit not as high as the 15 wt. % counterpart, the SEM image shown in FIG. 17 revealed some level of aggregations of neat PI, likely limiting the dielectric performance. Another notable observation was the influence of dispersant on the dielectric performance of samples, as discussed previously. Direct comparison of the dielectric constants of samples with and without dispersant shown in FIG. 18 clearly illustrates the importance of the dispersant due its ability to support a homogenous, well-distributed system of ceramic particles coated in a PI matrix.

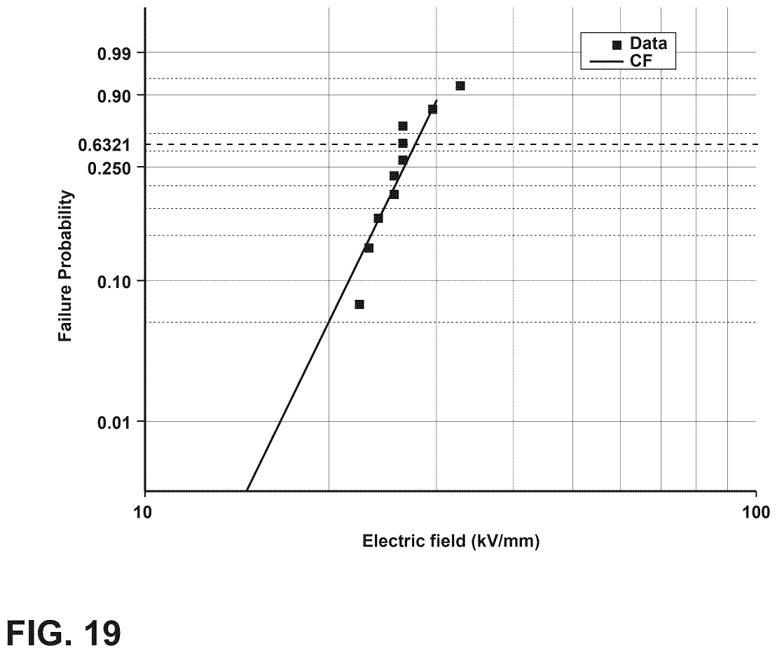

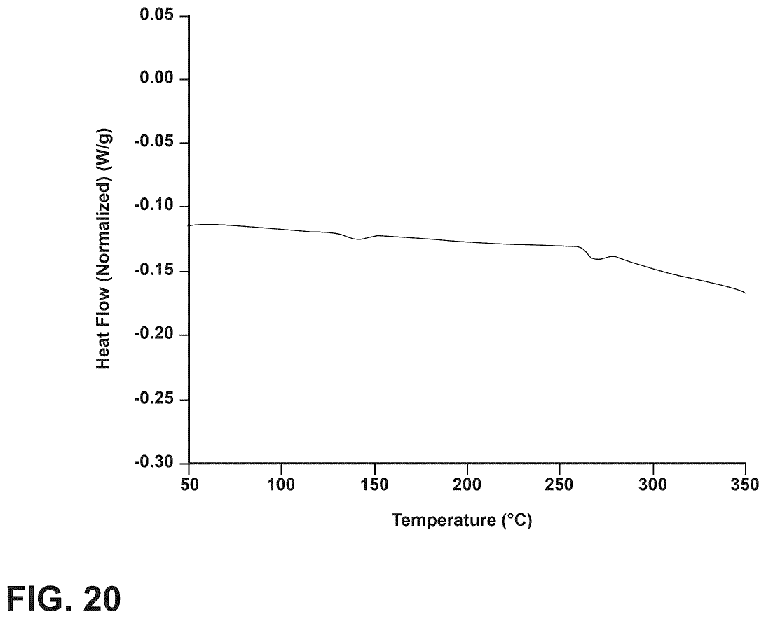

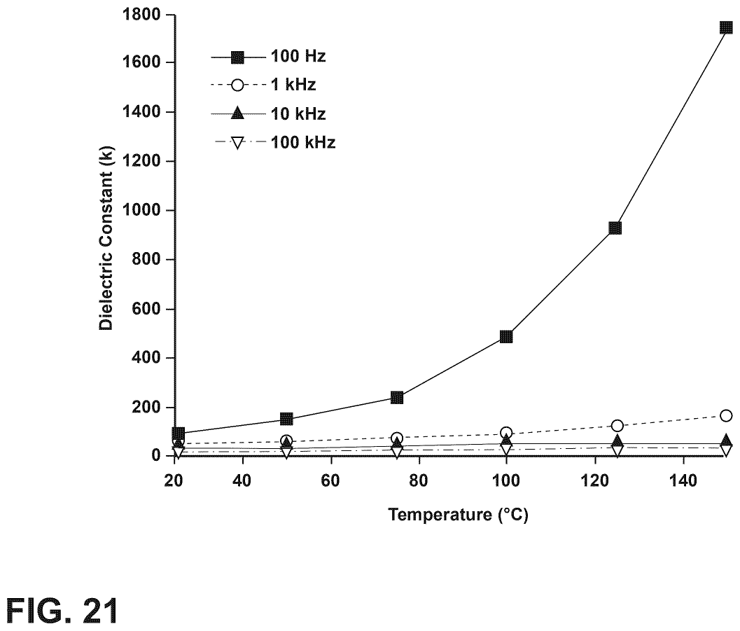

To determine the potential of the optimized formulation in a real-world setting, the breakdown strength and effective working temperature of the sample containing 30 vol. % CCTO, 5 wt. % dispersant, and 15 wt. % PI were measured. The Weibull plot shown in FIG. 19 indicates a breakdown strength of around 35.4 kV/mm. Based on a differential scanning calorimetry (DSC) technique, the working temperature of the same sample was verified to be in excess of 200° C., as the DSC data in FIG. 20 showed a glass transition temperature (T_{g}) of ˜265° C. To determine the real-world performance of the dielectric composite, its dielectric constant at elevated temperatures was also tested between 30-150° C. FIG. 21 shows an increasing trend of the dielectric constant with an increase in temperature. Particularly, at a low frequency regime (100 Hz) the dielectric performance showed a remarkable 700% improvement in going from 30° C. to 150° C. This indicates that CCTO governs the temperature dependent improved performance, likely associated with the high curie temperature of the CCTO.

A summary of the synthesized examples, comparative examples (0 wt. % dispersant), and their dielectric constant at 100 Hz are summarized in Table 2 below. The high-performance polymer-ceramic composite dielectric material demonstrated a dielectric constant of 250 at 100 Hz and 25° C., while being capable of operating above 200° C. and maintaining a high breakdown strength. The dielectric performance also improved drastically with increasing temperature. In certain embodiments, the composite dielectric material included 0 vol. % CCTO with 5 wt. % dispersant and 15 wt. % PI. The presence of the dispersant produced well-distributed ceramic nanoparticles in the PI matrix. The steric stabilization provided by the dispersant likely enabled a uniform and stable dispersion, while the high-temperature compatible PI matrix supported the CCTO after casting.

TABLE 2
Example polymer-ceramic composite dielectric materials at 100 Hz

| PI/NMP | CCTO | Dispersant | Temperature | Dielectric |
|---|---|---|---|---|
| wt. % | vol. % | wt. % | (° C.) | constant |
| 10 | 30 | 0 | 25 | 30 |
| | 35 | | | 29 |
| | 40 | | | 31 |
| | 45 | | | 44 |
| 20 | 45 | 1 | | 33 |
| | | 3 | | 56 |
| | | 5 | | 85 |
| 15 | 45 | 5 | | 113 |
| 18 | | | | 102 |
| 20 | | | | 85 |
| 20 | 20 | 5 | | 41 |
| | 30 | | | 140 |
| | 40 | | | 115 |
| | 45 | | | 113 |
| 10 | 30 | 5 | | 86 |
| 15 | | | | 250 |
| 20 | | | | 140 |
| 25 | | | | 79 |
| 15 | 30 | 0 | | 32 |
| 20 | | | | 42 |
| 15 | 30 | 5 | 25 | 94 |
| | | | 50 | 154 |
| | | | 75 | 240 |
| | | | 100 | 489 |
| | | | 125 | 928 |
| | | | 150 | 1745 |

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of manufacturing a high-performance polymer-ceramic composite dielectric material, the method comprising:
mixing a high-temperature polymer with a solvent to obtain a first mixture;
adding a high-energy-density ceramic material to the first mixture to obtain a second mixture;
mixing a dispersant with the second mixture to obtain a slurry composition;
tape-casting the slurry composition on a substrate at an elevated temperature of greater than or equal to 25° C.;
drying the casted slurry composition to obtain a polymer-ceramic dielectric film; and
annealing the polymer-ceramic dielectric film.

2. The method of claim 1, wherein the high-temperature polymer has a glass transition temperature greater than or equal to 200° C.

3. The method of claim 2, wherein the high-temperature polymer is one or more selected from a group consisting of: polyimide (PI), polyamide-imide (PAI), polyetheretherketone (PEEK), polyetherketoneketone (PEKK), polyetherketone (PEK), polyethersulfone (PES), polyetherimide (PEI), polyphenylene sulfide (PPS), polytetrafluoroethylene (PTFE), polybenzimidazole (PBI), polyphthalamide (PPA), liquid-crystal polymer (LCP), and bisbenzocyclobutene (BCB).

4. The method of claim 3, wherein the high-temperature polymer is polyimide (PI).

5. The method of claim 1, wherein the high-energy-density ceramic material has a dielectric constant that is greater than or equal to 200 at a temperature greater than or equal to 25° C. and a frequency greater than or equal to 100 Hz.

6. The method of claim 5, wherein the high-energy-density ceramic material is one or more selected from a group consisting of: calcium copper titanate (CCTO), barium titanate, lead lanthanum zirconium titanate (PLZT), and silver niobate.

7. The method of claim 6, wherein the high-energy-density ceramic material is calcium copper titanate (CCTO).

8. The method of claim 1, wherein the solvent is a high-boiling polar aprotic organic solvent.

9. The method of claim 8, wherein the solvent is one selected from a group consisting of dimethylformamide (DMF), N-methyl-2-pyrrolidone (NMP), and dimethylacetamide (DMAC).

10. The method of claim 1, wherein the dispersant is one or more selected from a group consisting of: an alkylol ammonium salt, a polyglycol polyester modified polyalkylene imine, a modified styrene-maleic acid copolymer, phosphoric acid ester, and a charged, amphiphilic or zwitterionic compound.

11. The method of claim 10, wherein the dispersant is an alkylol ammonium salt of an acidic copolymer.

12. The method of claim 11, wherein the dispersant is an alkylol ammonium salt of an acidic copolymer having pendant amine and acid groups.

13. The method of claim 1, wherein a content of the high-temperature polymer in the first mixture is in a range of approximately 5 to 25 wt. %.

14. The method of claim 13, wherein the content of the high-temperature polymer in the first mixture is in a range of approximately 10 to 25 wt. %.

15. The method of claim 1, wherein a content of the high-energy-density ceramic material in the second mixture is in a range of approximately 20 to 50 vol. %.

16. The method of claim 15, wherein the content of the high-energy-density ceramic material in the second mixture is in a range of approximately 30 to 45 vol. %.

17. The method of claim 1, wherein a content of the dispersant in the slurry composition is in a range of approximately 1 to 5 wt. %.

18. The method of claim 17, wherein the content of the dispersant in the slurry composition is in a range of approximately 3 to 5 wt. %.

19. The method of claim 1, wherein the annealed polymer-ceramic dielectric film has a dielectric constant that is greater than 200 at 100 Hz and 25° C.

20. A high-temperature capacitor comprising the high-performance polymer-ceramic composite dielectric material manufactured by the method of claim 1.

21. A high-performance polymer-ceramic composite dielectric material comprising:
a high-temperature polymer having a glass transition temperature greater than or equal to 200° C.;
a high-energy-density ceramic material having a dielectric constant that is greater than or equal to 200 at a temperature greater than or equal to 25° C. and a frequency greater than or equal to 100 Hz; and
a dispersant;
wherein the high-performance polymer-ceramic composite dielectric material has a dielectric constant that is greater than 200 at 100 Hz and 25° C.
